(19) United States
(12) Patent Application Publication
(10) Pub. No.: US 2026/0211808 A1
(43) Pub. Date: Jul. 23, 2026

(54) HIGH-SPEED READ DATA CAPTURE IN FLASH MEMORY CONTROLLER

(71) Applicant: Sandisk Technologies, Inc., Milpitas, CA (US)

(72) Inventors: ASHISH SAVADIA, Bangalore (IN); HANAN BORUKHOV, REHOVOT (IL)

(73) Assignee: Sandisk Technologies, Inc., Milpitas, CA (US)

(21) Appl. No.: 19/032,518

(22) Filed: Jan. 21, 2025

(51) Int. Cl. G06F 12/02

(52) U.S. Cl. CPC G06F 12/0246

(57) ABSTRACT

A storage device may perform high-speed read data capture. The storage device includes a memory device to send parallel data (DQ) aligned with a burst of differential clock strobes (DQS). The memory device may support warm-up cycles. The storage device also includes a controller including a DQS receiver to receive the DQS and data clocked comparators to receive the DQ. At the beginning of a data output burst, the DQS receiver receives warm-up DQS cycles and forwards the DQS it receives during the warm-up DQS cycles to the data clocked comparators. Following a configured number of warm-up cycles, the data clocked comparators may receive the DQ that are aligned with the DQS received by the DQS receiver after the configured number of warm-up cycles. The data clocked comparators may capture the DQ and the aligned DQS to capture read data at a high speed.

### BACKGROUND OF THE INVENTION

A storage device may be communicatively coupled to a host and to non-volatile memory including, for example, a NAND flash memory device on which the storage device may store data received from the host. A controller on the storage device may communicate with the memory device using a back-end controller-to-memory interface. The back-end controller-to-memory interface may be a source synchronous system, wherein components of the memory device or controller may send out parallel data (bits) on data lines (the data carried on the data lines are referred to herein as DQ). The parallel data may be aligned with a burst of differential clock strobes which act as timing signals indicating when the data on the DQ lines is stable and should be sampled (the clock strobes are referred to herein as DQS). The parallel data may be, for example, 8-bit parallel data or 16-bit parallel data.

In an architecture where, for example, the memory device sends parallel data to the controller, the memory device may include data drivers that may be used to send the data to the controller. For example, when the memory device is sending 8-bit parallel data to the controller, the memory device may include eight data drivers (for example, DQ0 driver-DQ7 driver), each of which may be used to send one bit in the 8-bit data in parallel to the controller. The memory device may also include a DQS driver that may send the strobes that are aligned with the data to the controller.

The controller may include corresponding receivers (for example, DQ0 receiver-DQ7 receiver) for the DQ0-DQ7 drivers in the memory device. Each data receiver (i.e., DQ0-DQ7 receivers) may have an associated flipflop circuitry and each data receiver may forward data received from the memory device through an associated data delay line to the associated flipflop circuitry. Based on the placement of the data receivers, there may be a timing penalty in transporting the data from a data receiver to the associated flipflop circuitry, with the delay time from the data receiver to an associated flipflop circuitry being approximately 400 microns (μm). The controller may also include a corresponding DQS receiver for the DQS driver in the memory device. Based on the placement of the DQS receiver, the delay time from the DQS receiver to a flipflop circuitry associated with, for example, the DQ0 receiver or the DQ7 receiver may be approximately 800 μm. The flipflop circuitry for each data receiver may capture the data received by that data receiver and the aligned strobe.

A read data burst from the memory device to the controller may follow a strict timing requirement along the data and strobe lines so that the data and strobe may remain aligned under external power/voltage/temperature (PVT) conditions. As noted, because of the placement of the data receivers and the clock receiver in the controller, there is currently a large timing penalty in transporting the data at a given speed (for example, 4800 megabits per second (MBPS)) from a data receiver to an associated flipflop circuitry. As such, the current architecture may not be scalable to allow for read data capture, at higher speeds, in the controller.

The controller may implement a decision feedback equalizer to boost the data signals. The decision feedback equalizer may be limited to one tap (i.e., for each data (bit) received, the controller may equalize the current data (bit) received by the data receiver based on the immediate previous data (bit) received by the data receiver). When a flipflop circuitry for a data receiver captures the current data and strobe signal, due to the delay path from the data receiver to the associated flipflop circuitry the controller may be unable to loop back to the data receiver to use the previous data received by that data receiver to equalize the current data. As such the decision feedback equalizer used on the storage device may be a one tap lookahead Decision Feedback Equalizer (DFE) receiver, wherein for each data line, multiple samples for data received on a data receiver may be created. One of the samples may be selected and stored. A sample may be selected based on the immediate previous data selected for the data line. With this architecture, to increase the number of previous bits used in selecting a sample, the number of receivers associated with a data line may be increased, which may be cost prohibitive. As such, the controller may not equalize the current data based on more than one tap. For example, the controller may not equalize the current data using two taps (i.e., the two immediate previous data received/selected for a data receiver), three taps (i.e., three immediate previous data received/selected for a data receiver), and so on. As the storage device speed increases, the current data received by a data receiver may be impacted by more than the immediate previous data received by the data receiver. Limiting the storage device to a DFE receiver may thus interfere with demand for increased speed and power on the storage device.

### SUMMARY OF THE INVENTION

In some implementations, a storage device may perform high-speed read data capture. The storage device includes a memory device to send parallel data (DQ) aligned with a burst of differential clock strobes (DQS). The memory device may support warm-up cycles. The storage device also includes a controller including a DQS receiver to receive the DQS and data clocked comparators to receive the DQ. At the beginning of a data output burst, the DQS receiver receives warm-up DQS cycles and forwards the DQS it receives during the warm-up DQS cycles to the data clocked comparators. Following a configured number of warm-up cycles, the data clocked comparators receive the DQ that are aligned with the DQS received by the DQS receiver after the configured number of warm-up cycles. The data clocked comparators may capture the DQ and the aligned DQS to perform read data capture at high speed.

In some implementations, a method is provided for performing high-speed read data capture in a storage device. The method includes, at the beginning of a data output burst, receiving, by a DQS receiver in the controller, warm-up DQS strobes and forwarding the warm-up DQS strobes to data clocked comparators in the controller. The method also includes following a configured number of warm-up cycles, receiving, by the data clocked comparators, parallel data aligned with a burst of differential DQS strobes from a memory device. The DQ is aligned with the DQS received by the DQS receiver after the configured number of warm-up cycles. The method also includes capturing, by the data clocked comparators, the DQ and the aligned DQS to perform read data capture at high speed in the data clocked comparators.

In some implementations, a storage device may perform high-speed read data capture and multi-tap equalization. The storage device includes a memory device that may support warm-up cycles and send parallel DQ aligned with a burst of DQS. The storage device also includes a controller including an input/output bank including a DQS receiver and data clocked comparators. At the beginning of a data output burst, the DQS receiver may receive warm-up DQS strobes and forwards the warm-up DQS strobes to the data clocked comparators, Following a configured number of warm-up cycles, the data clocked comparators may receive the DQ that are aligned with the DQS received by the DQS receiver after the configured number of warm-up cycles. The data clocked comparators may include circuitry to capture the DQ and the aligned DQS to perform read data capture at high speed. The data clocked comparators may also equalize a current DQ with at least one previous data stored on local registers that are associated with the data clocked comparators.

### BRIEF DESCRIPTION OF THE DRAWINGS

FIG. 1 is an example schematic diagram of a current source synchronous system 100.

FIG. 2 is a further schematic diagram of the controller of FIG. 1 including a lookahead decision feedback equalizer.

FIG. 3 is a schematic diagram of an example controller used in accordance with some implementations.

FIG. 4 is a schematic diagram of an example of a clocking mechanism in a controller in accordance with some implementations.

FIG. 5 is an example flow diagram for performing high-speed read data capture in a controller used in a storage device in accordance with some implementations.

FIG. 6 is a diagram of an example environment in which systems and/or methods described herein are implemented.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

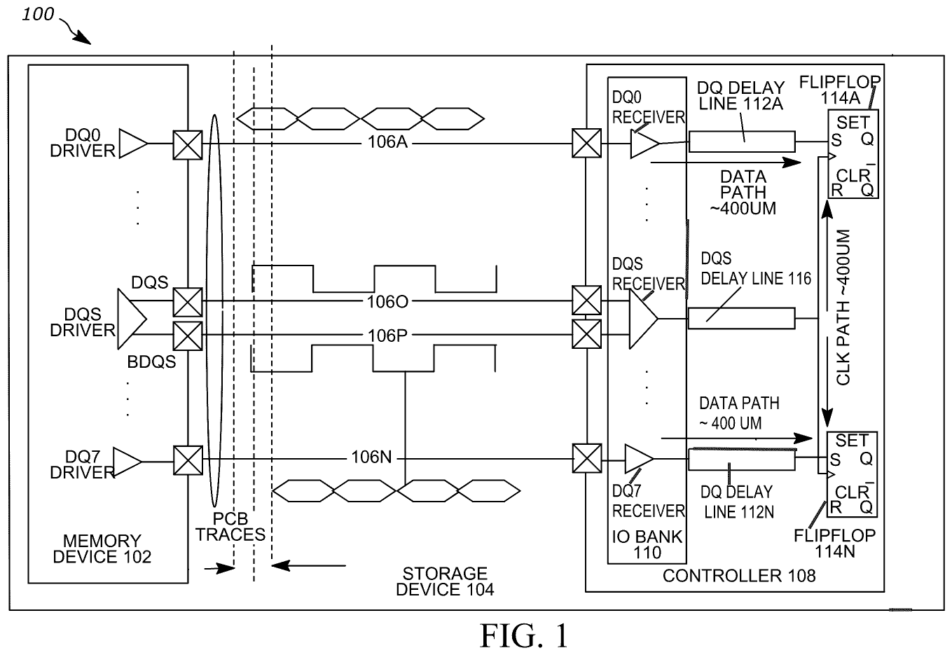

FIG. 1 is an example schematic diagram of a current source synchronous system 100. System 100 may include a memory device 102 that may be included in a storage device 104 or may be otherwise communicatively coupled to storage device 104. Memory device 102 may be flash based. For example, memory device 102 may be a NAND or NOR flash memory that may be used for storing host and control data over the operational life of memory device 102.

Storage device 104 may be, for example, a solid-state drive (SSD) that may operate in one or more modes using one or more protocols. Storage device 104 may include a controller 108 that may interface with memory device 102 using a back-end controller-to-memory interface. The back-end controller-to-memory interface may be a source synchronous system, wherein components of memory device 102 or controller 108 may send out parallel data (DQ) that may be aligned with a burst of differential clock strobes (DQS). The parallel data may be, for example, 8-bit parallel data or 16-bit parallel data.

Controller 108 may communicate with memory device 102 via a bus that may include data lines 106a-106n (where n is the number of bits being received in parallel by controller 108) and clock lines 106o and 106p. Data lines 106a-106n and clock lines 106o and 106p may generally referred to as data and/or clock line(s) 106. Using data and clock lines 106, memory device 102 may send parallel data that may be aligned with a burst of differential clock strobes. Controller 108 may also interface with a host (not shown) and process foreground operations including instructions transmitted from the host. For example, controller 108 may read data from and/or write to memory device 102 based on instructions received from the host. Controller 108 may also execute background operations to manage resources on memory device 102. For example, controller 108 may execute garbage collection, read refresh, and other relocation functions per internal relocation algorithms to refresh, recycle, and/or relocate the data on memory device 102.

For the sake of simplicity, FIG. 1 shows components of memory device 102 that are used to send data and clock signals from memory device 102 to controller 108 and the components of controller 108 that are used to receive data and clock signals from memory device 102. Controller 108 may include an input/output (IO) bank 110 including a clock (DQS) receiver and data (DQ0-DQN-1) receivers (where N is the number of bits being received in parallel by controller 108). When the memory device sends 8-bit parallel data, controller 108 may include eight data receivers (i.e., DQ0 receiver-DQ7 receiver), as shown in FIG. 1. When the memory device sends, for example, 16-bit parallel data, controller 108 may include sixteen data receivers (i.e., DQ0 receiver-DQ15 receiver (not shown)).

The data from each of DQ0 receiver-DQ7 receiver may go through an associated DQ delay line 112a-112n to an associated flipflop circuitry 114a-114n (referred to generally as flipflop circuitry 114). As such, data from DQ0 receiver may go through DQ delay line 112a to flipflop circuitry 114a; data from DQ1 receiver may go through DQ delay line 112b to flipflop circuitry 114b, and so on. There may be a timing penalty in transporting the data from a data receiver to an associated flipflop circuitry 114 of approximately 400 microns (μm). For example, 5-10 picoseconds of timing penalty may be expected for 400 μm routing when transporting the data from DQ0 receiver through DQ delay line 112a to flipflop circuitry 114a.

The DQS receiver may send the clock signal aligned with the data received on each of DQ0 receiver-DQ7 receiver through a clock delay line (i.e., DQS delay line 116) to an associated flipflop circuitry 114 of DQ0 receiver-DQ7 receiver. The associated flipflop circuitry 114 of DQ0 receiver-DQ7 receiver may capture the data received at that data receiver with the aligned clock strobe. There may also be a timing penalty of approximately 750-800 μm in transporting the clock from DQS receiver to the associated flipflop circuitry 114 of DQ0 receiver-DQ7 receiver. Due to the timing penalties associated with sending the data and the clock to flipflop circuitry 114, this current architecture may not be used to capture read data at higher speeds. FIG. 1 is provided as an example. Other examples may differ from what is described in FIG. 1.

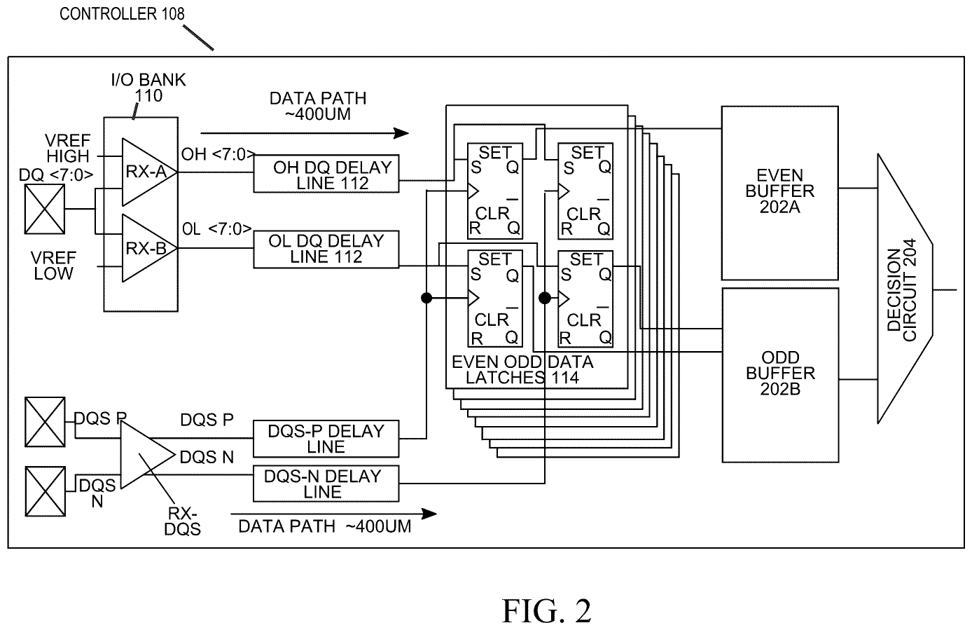

FIG. 2 is a further schematic diagram of the controller of FIG. 1 including a lookahead decision feedback equalizer. The schematic for DQ0 receiver-DQ7 receiver is overlaid in FIG. 2. Each DQ receiver (DQ <7:0>) may include two data receivers RX-A and RX-B to create two samples of the data (bit) received on the data line associated with the DQ receiver. The sample from RX-A may pass through OH DQ delay line 112 to a flipflop circuitry 114 associated with the DQ receiver and the sample from RX-B may pass through OL DQ delay line 112 to flipflop circuitry 114 associated with the DQ receiver. The clock signals DQSp and DQSn may pass through a receiver (RX-DQS) and DQS P delay lines and DQS N delay lines to flipflop circuitry 114 associated with DQ0 receiver-DQ7 receiver.

The aligned clock and data signals from RX-A may be stored in an even buffer 202a and the aligned clock and data signals from RX-B may be stored in an odd buffer 202b. Even buffer 202a and odd buffer 202b may be first-in-first-out (FIFO) buffers. Even buffer 202a may store the immediate previous data (bit) sent on RX-A and odd buffer 202b may store the immediate previous data (bit) sent on RX-B. A decision circuit 204 may use the immediate previous data (bit) selected for DQ0 receiver-DQ7 receiver and stored in even buffer 202a or odd buffer 202b to select one of the two outputs from data receiver RX-A and RX-B for a given DQ receiver. As such, controller 108 may execute a lookahead equalization scheme where an analog signal (DQ and DQS) may be converted to a digital signal using multiple references and later decision circuit 204 may select one of the two outputs from data receivers RX-A and RX-B based on a previous bit decision. Decision circuit 204 may be limited to one tap (i.e., for each DQ receiver, decision circuit 204 may equalize the current data (bit) received by the DQ receiver based on the immediate previous bit decision for the DQ receiver). FIG. 2 is provided as an example. Other examples may differ from what is described in FIG. 2.

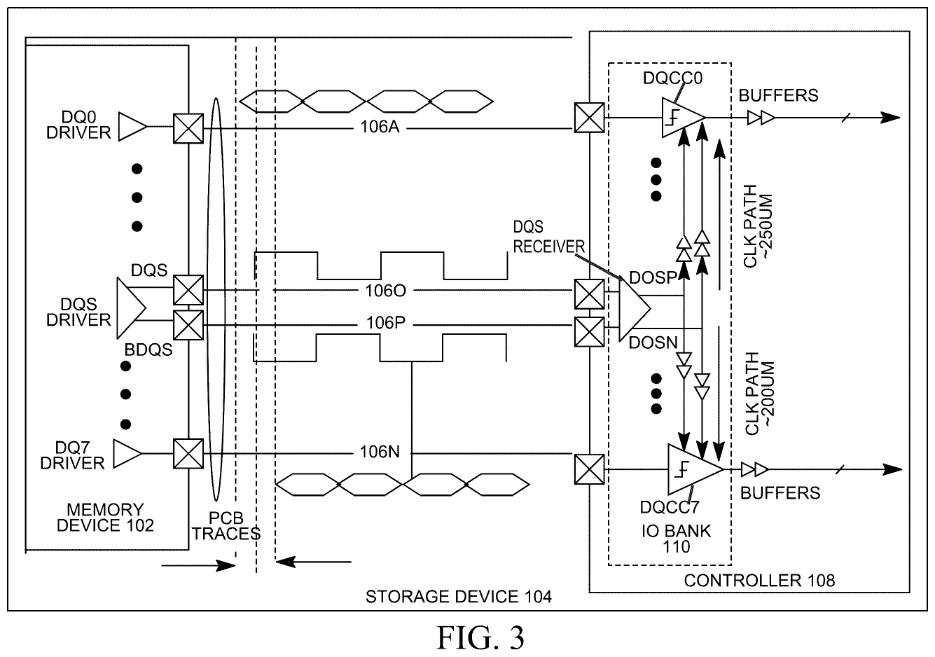

FIG. 3 is a schematic diagram of an example source synchronous system including a controller that may perform high-speed read data captured in accordance with some implementations. Controller 108 may include a clock (DQS) receiver and an input/output (IO) bank 110 including data clocked comparators (DQ CC0-DQ CC N-1) (where N is the number of bits being received in parallel by controller 108). When the memory device sends 8-bit parallel data, controller 108 may include eight data clocked comparators (i.e., DQ CC0-DQ CC7), as shown in FIG. 3. DQ CC0 DQ CC7 may be interpreted as including analog flipflop circuitry in IO bank 110. The DQS receiver may forward the DQS strobe aligned with the data received on each of DQ CC0-DQ CC7 directly to DQ CC0-DQ CC7. As such, each of DQ CC0-DQ CC7 may directly capture the data it received from memory device 102, rather than sending the data to an associated flip-flop circuitry and incur a delay penalty, as is shown in FIGS. 1 and 2.

As noted, memory device 102 may align data with strobes sent to controller 108. When data is received in each of DQ CC0-DQ CC7 without an aligned strobe, the data may be lost. To account for the delay associated with sending the DQS strobe from the DQS receiver to each of DQ CC0-DQ CC7 such that an initial data received in each of DQ CC0-DQ CC7 is not lost due to the absence of DQS strobes when the data is received in each of DQ CC0-DQ CC7, controller 108 may implement a warm-up/latency cycle-based source synchronous DQS strobe alignment.

Memory device 102 may be configurable to support, for example, from four to thirty-two warm-up cycles. Warm-up cycles for data output from memory device 102 (i.e., for read operations) may provide additional read enabled (REn) clock cycles (also referred to herein as warm-up DQS cycles) at the beginning of a data output burst. No valid data may be associated with these additional REn clock cycles/warm-up DQS cycles. The number of extra cycles may be configured via a set features address, for example set feature address 02h. For each REn warm-up cycle, controller 108 may receive a corresponding warm-up DQS strobes with no valid data. The first valid byte of data to be transmitted to controller 108 may be on the first REn rising edge following a configured number of REn warm-up cycles.

In implementing the warm-up/latency cycle-based source synchronous DQS strobe alignment where, for example, memory device 102 is configured to support four warm-up cycles, memory device 102 may send the first four cycles (i.e., the first four warm-up REn warm-up cycles/DQS strobe cycles) as DQS. As such, for the first four REn warm-up cycles, controller 108 may receive a corresponding DQS cycle with no valid data. The DQS receiver may forward the DQS strobe for the first four REn warm-up cycles directly to DQ CC0-DQ CC7. After the warm-up cycles, memory device 102 may transmit the first valid byte of data to controller 108 on the first REn rising edge. As the DQS receiver is sending DQS strobe to DQ CC0-DQ CC7 when the first valid byte of data is sent to controller 108, the valid data may be aligned, with minimal delay, to the strobe signals that are already being sent from the DQS receiver to each of DQ CC0-DQ CC7. As such, each of DQ CC0-DQ CC7 may capture the first valid byte of data it receives, overcoming any loss of data that would have otherwise been associated with the delays in sending the DQS strobe from the DQS receiver to DQ CC0-DQ CC7. After the data is transmitted to controller 108, the last four cycles of the DQS (referred to herein as the ending DQS cycles) may be discarded as there may be no valid data associated with those cycles. Depending on the speed and intrinsic DQS delay, the number of warm-up cycles can be reduced or increased during training.

As the data is now captured directly in each of DQ CC0-DQ CC7, local registers (not shown) associated with each DQ CC0-DQ CC7 may store the data so that the clocked comparators may be used for equalization. With the previous data known to DQ CC0-DQ CC7, controller 108 may implement multi-tap decision feedback equalization, wherein the current bit received in DQ CC0-DQ CC7 may be equalized based on information associated with one or more previous bits stored in the local registers. The multi-tap decision feedback equalization may improve the read performance, equalize high channel attenuation, and enable high level of scalability associated with increased speed.

Storage device 104 may perform these processes based on a processor, for example, controller 108 executing software instructions stored by a non-transitory computer-readable medium, such as storage component 102. As used herein, the term “computer-readable medium” refers to a non-transitory memory device. Software instructions may be read into storage component 102 from another computer-readable medium or from another device. When executed, software instructions stored in storage component 102 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 3 is provided as an example. Other examples may differ from what is described in FIG. 3.

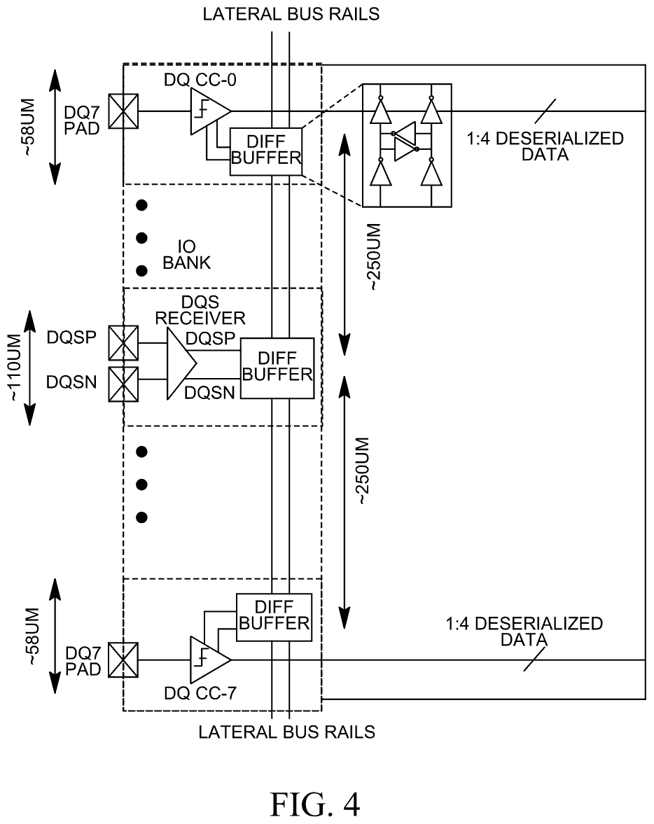

FIG. 4 is a schematic diagram of an example of a clocking mechanism in a controller in accordance with some implementations. Instead of routing the DQS strobes vertically and horizontally to forward the DQS strobe to a flipflop circuitry, as shown in FIG. 1, an efficient clocking mechanism along the lateral bus rails in IO bank 110 may be implemented. DQS receiver may convert an analog strobe into digital strobe and, through vertical buses, DQS receiver may directly transfer the strobe to DQ CC0-DQ CC7. For skew correction, rise and fall transition de-skewers may be placed in a differential buffer (diff buffer) which may be forwarded to DQ CC0-DQ CC7. The distance from DQS receiver to DQ CC0 or DQ CC7 is shown as approximately 250 μm, as opposed to the approximately 800 μm shown in FIG. 1.

The architecture shown in FIGS. 1 and 2, could not be scaled to perform high-speed read data capture due to the practical limitations associated with, for example, timing penalties in capturing the data in the flipflop circuitry 114. By converting DQ0 receiver-DQ7 receiver in FIGS. 1 and 2 to DQ CC0-DQ CC7 (as shown in FIGS. 3 and 4), the loss in DQ CC0-DQ CC7 may be scalable, wherein the RX analog loss may be reduced as the speed increases from, for example, 4800 MBPS up to 8400 MBPS.

There is no flipflop loss in the architecture shown in FIGS. 3 and 4 because the flipflop circuitry is not used. The elimination of the approximately 400 μm data path delay line (as shown in FIG. 1) and an approximately forty percent reduction in strobe routing paths (shown in FIG. 3) may make the architecture shown in FIG. 3 immune to data delay line noise. The approximately forty percent reduction in the strobe routing paths and elimination of data delay lines may also directly improve the power used in the architecture shown in FIG. 3. Since the power may be lowered, the consumption may be less with smaller capacitors on the supply lines, reducing the area used in the architecture shown in FIG. 3. For example, the area saved may be the area per-bit data delay line plus area that is not used for larger capacitors, which may be approximately 500 square μm. The architecture shown in FIGS. 3 and 4, may be compatible to all generations of NAND with speeds from, for example, 400 MBPS to 8400 MBPS. In addition, with multiple tap equalization, the DFE gain may be improved. Thus, with the architecture shown in FIGS. 3 and 4, system margins may increase with speed, components such as the flipflop circuitry and delay lines may be removed, the geometry may be reduced, multiple tap equalization may be enabled, and smaller capacitors may be used on the supply line to reduce supply noise.

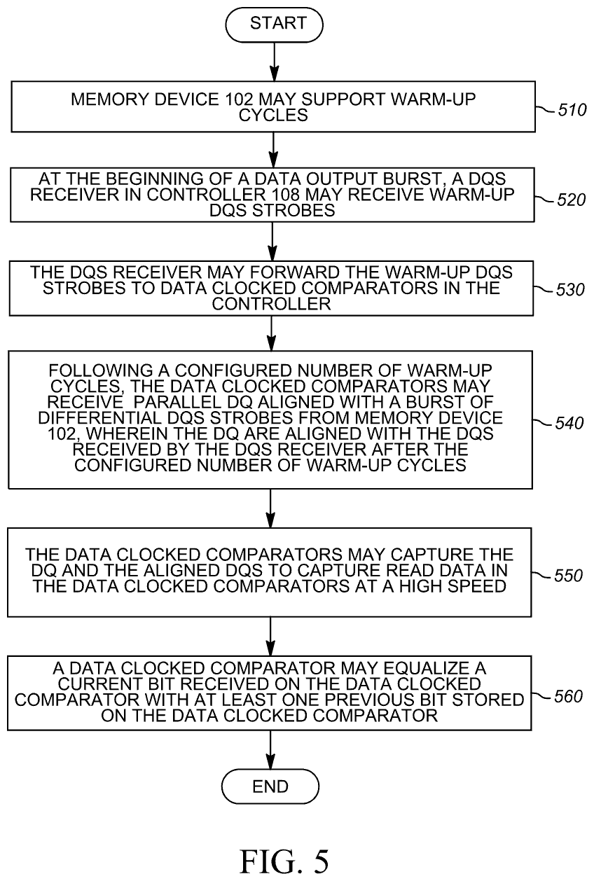

FIG. 5 is an example flow diagram for performing high-speed read data capture in a controller used in a storage device in accordance with some implementations. At 510, memory device 102 may support warm-up cycles. At 520, at the beginning of a data output burst, a DQS receiver in controller 108 may receive warm-up DQS strobes. At 530, the DQS receiver may forward the warm-up DQS strobes to data clocked comparators in the controller. At 540, following a configured number of warm-up cycles, the data clocked comparators may receive, parallel DQ aligned with a burst of differential DQS strobes from memory device 102, wherein the DQ are aligned with the DQS received by the DQS receiver after the configured number of warm-up cycles. At 550, the data clocked comparators may capture the DQ and the aligned DQS to capture read data in the data clocked comparators at a high speed. At 560, a data clocked comparator may equalize a current bit received on the data clocked comparator with at least one previous bit stored on the data clocked comparator. As indicated above FIG. 5 is provided as an example. Other examples may differ from what is described in FIG. 5.

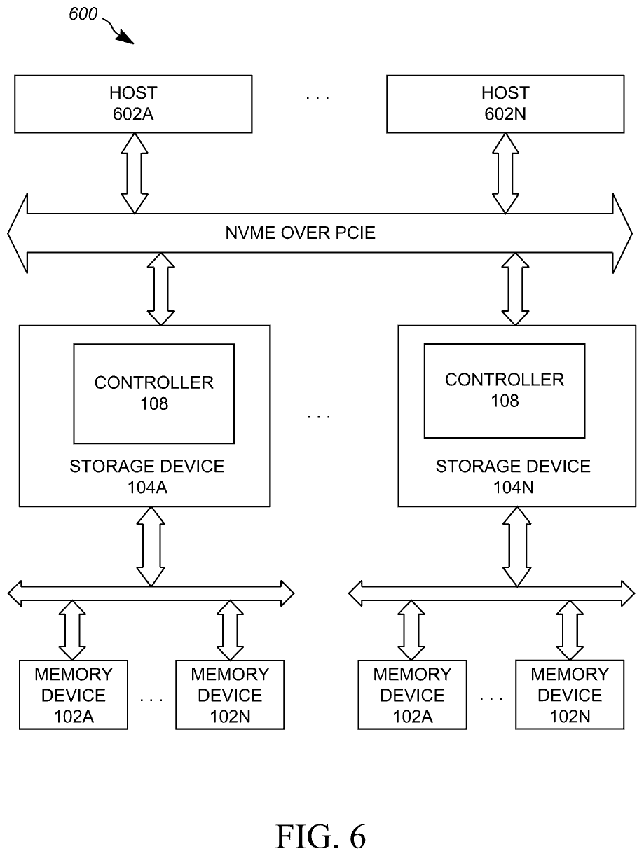

FIG. 6 is a diagram of an example environment in which systems and/or methods described herein are implemented. As shown in FIG. 6, Environment 600 may include hosts 602a-602n (referred to herein as host(s) 602), and one or more storage devices 104a-104n (referred to herein as storage device(s) 104). Storage device 104 may include a controller 108 to perform high-speed read data capture and execute multi-tap equalization. Hosts 602 and storage devices 104 may communicate via Non-Volatile Memory Express (NVMe) over peripheral component interconnect express (PCI Express or PCIe), SD, or the like.

Devices of Environment 600 may interconnect via wired connections, wireless connections, or a combination of wired and wireless connections. For example, the network in FIG. 6 may include NVMe over Fabric(NVMe-oF) Internet Small Computer Systems Interface (iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of Environment 600 may perform one or more functions described as being performed by another set of devices of Environment 600.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to perform high-speed read data capture, the storage device comprises:
a memory device to send parallel data (DQ) aligned with a burst of differential clock strobes (DQS), wherein the memory device supports warm-up cycles; and
a controller including
a DQS receiver to receive the DQS and
data clocked comparators to receive the DQ,
wherein at a beginning of a data output burst, the DQS receiver receives warm-up DQS cycles and forwards the DQS it receives during the warm-up DQS cycles to the data clocked comparators, and
following a configured number of warm-up cycles, the data clocked comparators receive the DQ that are aligned with the DQS received by the DQS receiver after the configured number of warm-up cycles, wherein the data clocked comparators capture the DQ and the aligned DQS to capture read data at a high speed.

2. The storage device of claim 1, wherein a local register associated with a data clocked comparator stores previous data received by the data clocked comparator.

3. The storage device of claim 1, wherein the controller equalizes a current bit received on a data clocked comparator with at least one previous bit stored on a local register associated with the data clocked comparator.

4. The storage device of claim 1, wherein the controller receives the DQS during the warm-up DQS cycles without valid data.

5. The storage device of claim 1, wherein the warm-up cycles from the memory device provide additional read enabled (REn) clock cycles at the beginning of the data output burst.

6. The storage device of claim 5, wherein no valid data is associated with the additional REn clock cycles.

7. The storage device of claim 5, wherein the controller receives a first valid byte of data on a first REn rising edge following a configured number of REn warm-up cycles.

8. The storage device of claim 5, wherein the additional REn clock cycles are configured with a set features address.

9. The storage device of claim 5, wherein the controller discards ending DQS clock cycles that are not associated with data.

10. The storage device of claim 1, wherein the memory device supports four to thirty-two warm-up cycles.

11. The storage device of claim 1, wherein the warm-up cycles are one of increased and reduced during training based on a DQS delay.

12. The storage device of claim 1, wherein the controller includes an input/output bank to store the DQS receiver and data clocked comparators.

13. A method for performing high-speed read data capture in a storage device, the storage device comprises a controller to execute the method comprising:
at a beginning of a data output burst, receiving, by a clock (DQS) receiver in the controller, warm-up DQS strobes;
forwarding, by the DQS receiver, the warm-up DQS strobes to data clocked comparators in the controller;
following a configured number of warm-up cycles, receiving, by the data clocked comparators, parallel data (DQ) aligned with a burst of differential DQS strobes from a memory device, wherein the DQ are aligned with the DQS received by the DQS receiver after the configured number of warm-up cycles; and
capturing, by the data clocked comparators, the DQ and the aligned DQS to perform read data capture at a high speed in the data clocked comparators.

14. The method of claim 13, further comprising storing previous data received by a data clocked comparator locally in a register so that the data is used by the data clocked comparator for equalization.

15. The method of claim 13, further comprising equalizing a current bit received on a data clocked comparator with at least one previous bit stored in a local register associated with the data clocked comparator.

16. The method of claim 13, further comprising receiving the warm-up DQS strobes without valid data.

17. The method of claim 13, further comprising receiving a first valid byte of data on a first REn rising edge following a configured number of REn warm-up cycles, wherein the warm-up cycles for data output from the memory device provide additional read enabled (REn) clock cycles at the beginning of the data output burst and no valid data is associated with the additional REn clock cycles.

18. The method of claim 17, further comprising discarding ending DQS clock cycles that are not associated with data.

19. The method of claim 17, further comprising one of increasing and reducing the warm-up cycles during training based on a DQS delay.

20. A storage device to perform high-speed read data capture and multi-tap equalization, the storage device comprises:
a memory device to send parallel data (DQ) aligned with a burst of differential clock strobes (DQS), wherein the memory device supports warm-up cycles; and
a controller including an input/output bank including a DQS receiver and data clocked comparators,
wherein at a beginning of a data output burst, the DQS receiver receives warm-up DQS strobes and forwards the warm-up DQS strobes to the data clocked comparators, and
following a configured number of warm-up cycles, the data clocked comparators receive the DQ that are aligned with the DQS received by the DQS receiver after the configured number of warm-up cycles,
wherein the data clocked comparators includes circuitry to capture the DQ and the aligned DQS and perform read data capture at a high speed and the data clocked comparators equalizes a current DQ with at least one previous data stored on local registers that are associated with the data clocked comparators.
